(19) United States
(12) Patent Application Publication
(10) Pub. No.: US 2006/0129310 A1
(43) Pub. Date: Jun. 15, 2006

(54) Method and apparatus for providing travel related information to a user

(76) Inventors: David R. Tarrant, Romsey (GB); Nicholas D.L. Thorne, Southampton (GB)

Correspondence Address: PHILIPS INTELLECTUAL PROPERTY & STANDARDS, P.O. BOX 3001, BRIARCLIFF MANOR, NY, 10510, US

(21) Appl. No.: 10/514,593

(22) PCT Filed: May 15, 2003
(86) PCT No.: PCT/IB03/02066

§ 371 Date: Nov. 16, 2004

(30) Foreign Application Priority Data
May 21, 2002 (GB) 0211566.5

(51) Int. Cl. G01C 21/34

(52) U.S. Cl. 701/201

(57) ABSTRACT

A method of providing travel related information to a user is disclosed together with corresponding apparatus for the same. The method comprising the steps of recording a history of journeys undertaken by the user, determining a current journey of the user, identifying one or more recorded journeys which correlate with the current journey; and providing travel related information to the user relating to that or those recorded journeys.

### RELATED INFORMATION TO A USER

This invention relates to a method of providing travel related information to a user comprising the steps of recording a history of journeys undertaken by the user and providing travel related information to the user relating at least one of those recorded journeys.

U.S. Pat. No. 6,199,010 B1 discloses a wireless telecommunications system that provides both telecommunications service and navigational assistance to travelers. In particular, the movement of a traveller during a trip is tracked and recorded and, at a later time when the traveller is making that same trip again and upon a specific request by the traveller, navigational directions are provided to the traveller (e.g., “turn left ahead at Maple Street,” etc.) based on the previous trip.

In accordance with the present invention, there is provided a method of providing travel related information to a user together with corresponding apparatus, the method comprising the steps of recording a history of journeys undertaken by the user; determining a current journey of the user; identifying one or more recorded journeys which correlate with the current journey; and providing travel related information to the user relating to that or those recorded journeys.

The travel related information may include the name of a location at the start, along or at the end of a recorded journey, for example, wherein the user is able to select the name of that location from a list comprising several locations to aid data entry.

Alternatively, the travel related information may include at least part of a recorded, traffic information broadcast, selectively provided to the user based on that or those recorded journeys which correlate with the current journey.

Where the recorded history includes routes of previous journeys, the travel related information may be provided based on that or those recorded journeys for which the route correlates with the current journey.

Alternatively, where the recorded history includes the timing of previous journeys, the travel related information may be provided based on that or those recorded journeys for which the timing correlates with the current journey. In particular, in identifying one or more recorded journeys which correlate with the current journey, a distinction may be made between weekday and weekend journeys.

As a yet further alternative, where the recorded history includes the number of people who travelled in a vehicle during previous journeys (e.g. determined by sensors related to seats in the vehicle such as seatbelt fastened sensors), the travel related information may be provided based on that or those recorded journeys for which the number of people travelling in the vehicle correlates with the current journey.

The present invention is hereafter illustrated, by way of example only, with reference to the accompanying schematic drawings in which:

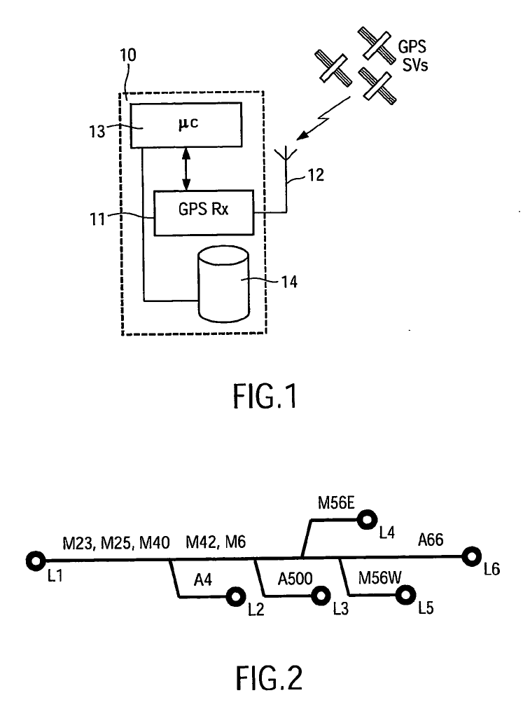

FIG. 1 shows satellite navigation apparatus employing a method of providing travel related information in accordance with the present invention;

FIG. 2 illustrates a scenario in which a driver may drive to one of a number of possible destinations;

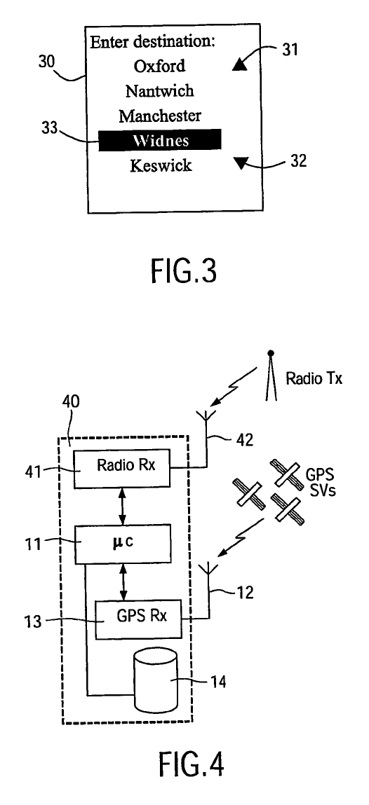

FIG. 3 shows a display of the satellite navigation apparatus of FIG. 1; and

FIG. 4 shows alternative satellite navigation apparatus employing a method of providing travel related information in accordance with the present invention.

FIG. 1 shows satellite navigation apparatus 10 comprising a GPS receiver (GPS Rx) 11 connected to a GPS antenna 12 and controlled by a microprocessor 13. When operative, the GPS signals may be acquired and tracked for the purpose of deriving pseudorange information from which the location of the apparatus can be determined using conventional navigation algorithms. Such methods for GPS signal acquisition, tracking and position determination are well known, for example, GPS Principles and Applications (Editor, Kaplan) ISBN 0-89006-793-7 Artech House.

The satellite navigation apparatus is located in a vehicle (not shown) and is configured to record journeys undertaken by the vehicle in a database 14.

For the purposes of illustration and with reference to FIG. 2, a scenario is considered in which a driver of a vehicle containing the satellite navigation apparatus of FIG. 1 has previously driven from Gatwick in England to Oxford (L2) using motorways M23, M25 and M40 and secondary road A40; Nantwich (L3) using motorways M23, M25, M40, M42 and M6 and secondary road A500; Manchester (L4) using motorways M23, M25, M40, M42, M6 and M56(Eastbound); Widnes (L5) using motorways M23, M25, M40, M42, M6 and M62(Westbound); and Keswick (L6) using motorways M23, M25, M40, M42 and M6 and secondary road A66. Furthermore, the satellite navigation apparatus has recorded the routes of these previous journeys in the database 14.

The driver has then commenced a further journey from Gatwick (L1) wherein the driver is currently driving along motorway M40 to the driver's intended destination, Widnes (L5) whereby the driver has already driven along motorways M23 and M25 to get to motorway M40 from Gatwick.

Whilst driving along the M40, suppose that the driver wishes to use the satellite navigation apparatus to determine the distance from the driver's current location (provided automatically by the GPS receiver) to the driver's intended destination Widnes (L5) which the driver is required to input. Whilst the driver could manually enter their intended destination, it is preferable to minimise the onus on data entry by the driver by providing a list of likely destinations for the driver to choose the correct one. In the above scenario, the satellite navigation apparatus identifies that the driver's current journey corresponds to the first parts of previous journeys to Oxford, Nantwich, Manchester, Widnes and Keswick and displays to the driver a list of these locations on the assumption that the driving is intending to repeat a previous journey.

Such a display 30 is illustrated in FIG. 3 where one of the list is highlighted 33 to indicate the currently selected option, and two graphics are displayed 31, 32 to indicated that the driver can scroll up and down to change the selected option using an appropriate user interface (not shown). Once the intended location is entered by the driver, the satellite navigation apparatus may determine the distance from the driver's current location to the driver's intended location and, optionally, other information such as an estimated time of arrival and projected fuel consumption.

FIG. 4 shows alternative satellite navigation apparatus employing a method of providing travel related information in accordance with the present invention. In addition to the components of the apparatus of FIG. 1, the apparatus of FIG. 4 further comprises a radio receiver 41 for receiving terrestrial radio broadcasts from a nearby radio transmitter.

These radio broadcasts which carry travel information are recorded by the satellite navigation apparatus, selectively filtered and provided to the driver on request based on a predicted route or destination. That is, only that travel information based on the driver's driving history which is relevant to the driver's current journey is provided to the driver.

In the above examples, the apparatus utilises a display but of course, the travel related information could be provided a different way including audibly.

Also, the apparatus need not use GPS to determine its position but any other suitable positioning means. For example, telephone network positioning could be utilised where the invention is implemented in a mobile telephone and where this is the case, journeys could be undertaken by foot, public transport or any other means.

Implementation of a method according to the present invention in such a satellite navigation system, mobile telephone, mobile computer system and the like can be readily accomplished in hardware, in software (either in situ on a computer or stored on storage media) by appropriate computer programming and configuration or through a combination of both. Of course, such programming and configuration is well known and would be accomplished by one of ordinary skill in the art without undue burden.

1. A method of providing travel related information to a user comprising the steps of:
recording a history of journeys undertaken by the user;
determining a current journey of the user;
identifying one or more recorded journeys which correlate with the current journey; and
providing travel related information to the user relating to that or those recorded journeys.

2. A method according to claim 1 wherein the travel related information includes the name of a location at the start, along or at the end of a recorded journey

3. A method according to claim 1 wherein the travel related information includes at least part of a recorded, traffic information broadcast selectively provided to the user based on that or those recorded journeys which correlate with the current journey.

4. A method according to claim 1 wherein the recorded history includes routes of previous journeys, and wherein the travel related information is provided based on that or those recorded journeys for which the route correlates with the current journey.

5. A method according to claim 1 wherein the recorded history includes the timing of previous journeys, and wherein the travel related information is provided based on that or those recorded journeys for which the timing correlates with the current journey.

6. A method according to claim 5 wherein, in identifying one or more recorded journeys which correlate with the current journey, a distinction is made between weekday and weekend journeys.

7. A method according to claim 1 wherein the recorded history includes the number of people who travelled in a vehicle during previous journeys, and wherein the travel related information based on that or those recorded journeys for which the number of people travelling in the vehicle correlates with the current journey.

8. A method according to claim 7 wherein the number of people travelling in the vehicle is determined by sensors related to seats in the vehicle such as seatbelt fastened sensors.

9. Apparatus for providing travel related information to a user comprising:
means for recording a history of journeys undertaken by the user;
means for determining a current journey of the user;
means for identifying one or more recorded journeys which correlate with the current journey; and
means for providing travel related information to the user relating to that or those recorded journeys.

10. Apparatus according to claim 9 wherein the travel related information includes the name of a location at the start, along or at the end of a recorded journey

11. Apparatus according to claim 11 wherein the travel related information includes at least part of a recorded, traffic information broadcast selectively provided to the user based on that or those recorded journeys which correlate with the current journey.

12. Apparatus according to claim 9 wherein the recorded history includes routes of previous journeys, and wherein the travel related information is provided based on that or those recorded journeys for which the route correlates with the current journey.

13. Apparatus according to claim 9 wherein the recorded history includes the timing of previous journeys, and wherein the travel related information is provided based on that or those recorded journeys for which the timing correlates with the current journey.

14. Apparatus according to claim 13 wherein, in identifying one or more recorded journeys which correlate with the current journey, a distinction is made between weekday and weekend journeys.

15. Apparatus according to claim 9 wherein the recorded history includes the number of people who travelled in a vehicle during previous journeys, and wherein the travel related information based on that or those recorded journeys for which the number of people travelling in the vehicle correlates with the current journey.
